(19) United States
(12) Patent Application Publication
(10) Pub. No.: US 2015/0037658 A1
(43) Pub. Date: Feb. 5, 2015

(54) STACK TYPE BATTERY

(71) Applicant: SANYO Electric Co., Ltd., Moriguchi-shi, Osaka (JP)

(72) Inventors: Hitoshi Maeda, Hyogo (JP); Yoshio Goda, Hyogo (JP); Masayuki Fujiwara, Hyogo (JP); Yoshitaka Shinyashiki, Hyogo (JP); Yoshihiro Matsushita, Hyogo (JP)

(73) Assignee: SANYO ELECTRIC CO., LTD., Moriguchi-shi, Osaka (JP)

(21) Appl. No.: 14/384,880

(22) PCT Filed: Mar. 21, 2013
(86) PCT No.: PCT/JP2013/058014

§ 371 Date: Sep. 12, 2014

(30) Foreign Application Priority Data
Mar. 30, 2012 (JP) 2012-079202

(51) Int. Cl. H01M 2/26

(52) U.S. Cl. CPC H01M 2/266
USPC 429/161

(57) ABSTRACT

In a stack type battery containing a stacked electrode assembly in which a positive electrode plate having a positive electrode current collector tab extending therefrom and a negative electrode plate having a negative electrode current collector tab extending therefrom are alternately stacked interposing a separator therebetween, a through portion for positioning that passes through in the thickness direction is formed in at least one of the positive and negative electrode current collector tab, and the width at the through portion-unformed position of the positive or negative electrode collector tab is 50 mm or more, and the width of the through portion for positioning is 10% or less of the width at the through portion-unformed position of the positive or negative electrode current collector tab.

### TECHNICAL FIELD

The present invention is related to a stack type battery.

### BACKGROUND ART

Recently, batteries are used as not only power supplies for mobile data terminals such as cell phones, portable personal notebook computers, PDAs, and the like, but also power supplies for robots, electric vehicles, back-up power sources, and the like, thereby leading to a demand for a higher capacity. For such requirements, lithium ion batteries having a high energy density and high capacity are widely used as the above power supplies.

The battery configurations of the lithium ion batteries are broadly classified into a spiral type in which a spiral electrode assembly is inserted into an outer case and a stack type (a stack type prismatic battery) in which a stacked electrode assembly stacking plural square electrode plates is inserted into an outer can or an laminate outer case made from laminate film by welding.

Of these lithium ion batteries, the specific structure of the stacked electrode assembly in the stack type battery is configured that a required number of sheet-shaped positive electrode plates each having a positive electrode current collector tab extending therefrom and a required number of sheet-shaped negative electrode plates each having a negative electrode current collector tab extending therefrom are alternately stacked interposing the separators therebetween. Further, stacked plural positive electrode current collector tabs and negative electrode current collector tabs are each bundled and connected to a positive or negative electrode current collector terminal, thereby forming each current collecting portion. (Here, in this specification, the term “current collecting portion” means, fundamentally, wide concept containing members for current collecting such as positive electrode current collector tabs, negative electrode current collector tabs, a positive electrode current collector terminal, and a negative electrode current collector terminal, and their periphery space. Especially, when the above term is used in a narrow sense, it includes positive electrode current collector tabs, negative electrode current collector tabs, and their connecting portions.)

In the current collecting portion of the above stack type battery, it is required that the positive or negative electrode current collector tabs are easily and surely welded. In addition, there is needed a safety measure against abnormal heat generation of the battery or the like. In response to these requirements, various structures of the current collecting portion are proposed.

For example, as disclosed in patent literature 1 and 2, in order to easily bundle negative current collector tabs by bending them, it is proposed that a sectional area in the negative current collector tabs is made locally small. In patent literature 1, it is disclosed that the sectional area of the current collector tab is reduced to 5 to 90%. Additionally, it is known that, at the time of a short circuit current, by fusing at such a small sectional area portion, it works as a function of a fuse, and it prevents abnormal heat generation.

### CITATION LIST

### Patent Literature

Patent Literature 1:
Japanese Laid-Open Utility Model 1994(=Hei6)-11258

Patent Literature 2:
Japanese Laid-Open Patent Publication No. 1995(=Hei7)-226197

### SUMMARY OF THE INVENTION

On the other hand, in the above stack type battery, when the positive electrode plates and the negative electrode plates are stacked interposing the separators, there is a possibility that stack misalignment occurs. When the stack misalignment occurs due to a contact between the positive electrode plates and the negative electrode plates, a short circuit easily occurs.

At this time, for example, when the negative electrode plate is the same size as the separator and the negative electrode plates protrude from the separators, the stack misalignment is easily found from outside. On the other hand, at an end edge from which a negative electrode current collector tab extends, namely an end edge to the current collecting portion side of the negative electrode plate, an end edge of the separator facing the negative electrode extends outside beyond the end edge of the negative electrode plate, thereby being configured to prevent a short circuit on the negative electrode plate. In this configuration, even though the stack misalignment occurs at the end edge to the current collecting portion side of the negative electrode plate, as the negative electrode plate hardly protrudes from the separator, it is difficult to find the stack misalignment from outside.

The problem of the stack misalignment at the end edge to the current collecting portion side is not considered in the above patent literature 1 and 2. Therefore, the current collecting portion structure which effectively resolves the problem of the stack misalignment is required.

In view of the aforementioned problems, the present disclosure aims to provide a stack type battery and a manufacturing method for the stack type battery in which stack misalignment in the stacked electrode assembly of the stack type battery can be easily detected.

A stack type battery of the present disclosure containing a stacked electrode assembly in which a positive electrode plate having a positive electrode current collector tab extending therefrom and a negative electrode plate having a negative electrode current collector tab extending therefrom are alternately stacked interposing a separator therebetween, comprises a through portion for positioning that passes through in the thickness direction formed in at least one of the positive electrode current collector tab or the negative electrode current collector tab, and at an extending height position along the extending direction of the positive or negative electrode current collector tab having the through portion for positioning, the width in the direction perpendicular to the extending direction of the positive or negative electrode current collector tab at the through portion-unformed position where the through portion is not formed is 50 mm or more, and the width of the through portion for positioning in the direction perpendicular to the extending direction of the positive or negative electrode current collector tab is 10% or less, or preferably less than 10%, or more preferably 5% or less of the width in the direction perpendicular to the extending direction of the positive or negative electrode current collector tab at the through portion-unformed position.

In the present disclosure, “the through portion” includes a cutout partially cut so as to form a step (a narrow width portion) at the end edge of the positive or negative electrode current collector tab, an opening (through hole) defined inside the end edge of the positive or negative electrode current collector tab.

Accordingly, for example, even when, to the end edge (herein after refers to as “the current collector-side end edge”) from which the positive and the negative electrode current collector tab extends, the end edge (hereinafter refers to as “the current collector-side end edge”) of the separator facing the positive or negative electrode plate, is formed so as to largely extend outside, the presence of position misalignment can be easily and accurately detected by inspecting the presence of the position misalignment between the through portion for positioning and the current collector-side end edge of the separator.

At this time, the width in the direction perpendicular to the extending direction of the positive or negative electrode current collector tab at the through portion-unformed position is 50 mm or more, and the width of the through portion for positioning is 10% or less, or preferably less than 10%, or more preferably 5% or less of the width of the positive or negative electrode current collector tab at the through portion-unformed position (a width left by subtracting the width of the through portion for positioning from the width of the positive or negative electrode current collector tab at the through portion-unformed position is 90% or more, or preferably more than 90%, or more preferably 95% or more of the width of the positive or negative electrode current collector tab at the through portion-unformed position). Even though the pass-through portion is formed in the positive or negative electrode current collector tab, the width of the positive or negative electrode current collector tab at the through portion-formed position can be 45 mm or more. Therefore, the sufficient sectional area of the positive or negative electrode current collector tab can be secured. Namely, though the sectional area of the positive or negative electrode current collector tab is decreased by forming the through portion for positioning at that position, the necessary sectional area can be obtained for the current collector tab to flow a large current.

Namely, this through portion can have the large sectional area at the through portion-formed position, because of the following reasons. The through portion for positioning does not have a function or an effect that the small sectional area portion disclosed in the above mentioned patent literature 1 and 2 facilitates bending of the current collector tab, and the through portion does not work as a function of a fuse by a short circuit current. Accordingly, the current collector tab is not fused by a large current at the through portion-formed position. Therefore, the stack type battery having the large stacked electrode assembly can be obtained.

It is desirable that the positive or negative electrode collector tab in which the through portion for positioning be formed is bent and connected to the positive or negative electrode collector terminal, and the through portion for positioning be located between the stacked electrode assembly and a bent portion.

Accordingly, even after forming the stacked electrode assembly, the presence of the position misalignment between the through portion for positioning and the current collector-side end edge of the separator can be inspected. In addition, as the through portion for positioning is located between the stacked electrode assembly and a bent portion, the through portion for positioning is clearly different from the portion which facilitates bending of the current collector tab.

It is desirable that in the positive or negative electrode collector tab in which the through portion for positioning be formed, a bending line (a crease) be made by bending in advance.

Accordingly, at the time of shaping the current collecting portion by bending the current collector tab, the current collector tab is easily and surely bent at a predetermined bending position. For example, bending at the through portion for positioning in error is effectively prevented.

Here, in this case, the bending line (the crease) is formed by bending each of the current collector tabs, or by bending the current collector tabs by 2 to 5 sheets of the current collector tabs. Further, as this bending is carried out before stacking the positive electrode plate, the negative electrode plate, and the separator, the bending line (the crease) can be formed in advance.

It is desirable that a stacked electrode assembly-side end edge of the through portion for positioning be located within a range of ±1 mm (preferably ±0.4 mm) from an the current collector-side end edge of the facing separator at an extending height position along the extending direction of the positive or negative electrode current collector tab.

Accordingly, as the stacked electrode assembly-side end edge of the through portion for positioning substantially coincides with the current collector-side end edge of the facing separator, the presence of the position misalignment between the through portion for positioning and the current collector-side end edge of the facing separator can be exactly inspected. Namely, by forming the through portion for positioning in this position, the stack misalignment in the state of the stacked electrode assembly can be easily inspected.

In this case, for example, when the stacked electrode assembly-side end edge of the through portion for positioning projects from the current collector-side end edge of the facing separator by 1 mm or more (or 0.4 mm or more), it is determined that the stack misalignment occurs.

It is desirable that the separator have a bag-shape, and the positive or negative electrode plate be stored in the bag-shaped separator.

Accordingly, it is surely prevented that a short circuit occurs due to a contact between the positive electrode plate and the negative electrode plate caused by the stack misalignment.

The positive electrode plate, the negative electrode plate, and the bag-shaped separator have a square shape, and the positive electrode plate is stored in the bag-shaped separator, and the pass-through portion for positioning is formed in the negative electrode current collector tab, and three end edges of the negative electrode plate except for the current collector-side end edge thereof, and it is desirable that three end edges of the bag-shaped separator except for the current collector-side end edge thereof be located substantially on the same line.

Here, the end edge of the negative electrode plate and the end edge of the separator is located substantially on the same line, which means that one end edge is located within a range of approximately ±1 mm from the other end edge.

Normally, as the negative electrode plate is larger than the positive electrode plate, the above configuration storing the positive electrode plate in the bag-shaped separator enables the bag-shaped separator to be comparatively smaller than those storing the negative electrode plate. In this case, three end edges of the negative electrode plate except for the current collector-side end edge thereof, and three end edges of the bag-shaped separator except for the current collector-side end edge thereof are located substantially on the same line. Namely, by truing up three end edges of the negative electrode plate except for the current collector-side end edge thereof and three end edges of the bag-shaped separator except for the current collector-side end edge thereof, when the stack misalignment in the three end edges occurs, the negative electrode plate comparatively protrudes from the bag-shaped separator. Therefore, the stack misalignment is easily detected from the outside. In contrast, at the current collector-side end edge of the bag-shaped separator, a short circuit tends to occur since the separator cannot be welded at the position where the positive electrode current collector tab is disposed. Especially, it is desirable that a short circuit be prevented as much as possible by extending the current collector-side end edge of the separator largely outside the current collector-side end edge of the negative electrode plate facing the separator. However, in this structure of the current collector-side end edge, even though the stack misalignment occurs, it is difficult to detect the stack misalignment since the current collector-side end edge of the negative electrode plate does not protrude from the current collector-side end edge of the separator. Therefore, as mentioned above, by forming the through portion for positioning in the negative electrode current collector tab, the presence of the stack misalignment can be easily detected even in the current collector side-end edge.

It is desirable that the thickness of the positive or negative electrode current collector tab in which the through portion for positioning is formed be 0.03 mm or less.

Accordingly, the current collector tab is easily bent, and the current collecting portion is easily formed. Further, the stacked electrode assembly having high energy density can be obtained. Further, a member cost can be reduced.

It is desirable that of the positive or negative electrode current collector tabs in which the through portion for positioning is formed, the electrode current collector tabs of the same polarity be disposed at the position where they are each overlapped in the plan view.

Accordingly, as the positions of the through portions for positioning in the plural stacked positive electrode current collector tabs or negative electrode current collector tabs are trued up, the presence of the stack misalignment in the stacked electrode assembly can be easily inspected.

Further, a stacked battery in the present disclosure containing a stacked electrode assembly in which a positive electrode plate having a positive electrode current collector tab extending therefrom and a negative electrode plate having a negative electrode current collector tab extending therefrom are alternately stacked interposing the separators therebetween, comprises a projecting piece for positioning which projects from a part of an end edge of at least one of the positive and negative electrode plates.

For example, even when the end edge of the separator facing the end edge of the positive or negative electrode plate, is formed so as to largely extend outside, by inspecting the presence of a position slippage misalignment between the projecting piece for positioning and the end edge of the separator, the presence of the position slippage between the positive or negative electrode plate and the separator can be easily and accurately detected.

It is desirable that the projecting piece for positioning be formed at the current collector-side end edge of the at least one of the positive and negative electrode plates.

The projecting piece for positioning might be formed at any one of the end edges in the positive or negative electrode plate. However, as mentioned above, except for the current collector-side end edge, by truing up the side end edges of the negative electrode plate, and the side end edges of the facing separator, the stack misalignment is easily detected from outside when the stack misalignment in the side end edges occurs. On the other hand, in the current collector-side end edge, when the current collector-side end edge of the facing separator largely protrudes outside, it is difficult to detect the stack misalignment even though the stack misalignment occurs. Therefore, by forming the projecting piece for positioning, the presence of the stack misalignment can be easily and exactly detected.

It is desirable that at a projecting height position along the projecting direction of the projecting board for positioning, a tip portion of the projecting piece for positioning be located within a range of ±1 mm (preferably ±0.4 mm) from an end edge of the facing separator.

Accordingly, as the tip portion of the projecting piece for positioning substantially coincides with the end edge of the facing separator, the presence of the position misalignment between the projecting piece for positioning and the end edge of the separator can be exactly inspected. Namely, by forming the tip portion of the projecting piece for positioning in this position, the stack misalignment in the state of the stacked electrode assembly can be easily inspected.

In this case, for example, when the tip portion of the projecting piece for positioning projects from the end edge of the separator by 1 mm or more, it is determined that the stack misalignment occurs.

It is desirable that the width of the projecting board for positioning in the direction perpendicular to the projecting direction thereof be 1 to 10 mm.

When the width of the projecting piece for positioning in the direction perpendicular to the projecting direction thereof is 1 mm or more, the presence of the position misalignment between the projecting board piece and the facing separator is easily detected. Moreover, the projecting piece is good in mechanical strength, and it is hardly damaged. On the other hand, when the width of the projecting piece for positioning in the direction perpendicular to the projecting direction of the projecting piece is 10 mm or less, the width of the projecting piece is within a range not exceeding the required size. Accordingly, as in the case of the current collector tab, it is possible to suppress the unexpected increase in the portion susceptible to a short circuit.

It is desirable that the separator has a bag-shape, and the positive or negative electrode plate be stored in the bag-shaped separator.

Accordingly, it is surely prevented that a short circuit occurs due to a contact between the positive electrode plate and the negative electrode plate caused by the stack misalignment.

The positive electrode plate, the negative electrode plate, and the bag-shaped separator have a square shape, and the positive electrode plate is stored in the bag-shaped separator, and the projecting piece for positioning is formed at the current collector-side end edge of the negative electrode plate, and it is desirable that the three end edges of the negative electrode plate except for the current collector-side end edge thereof and the three end edges of the bag-shaped separator except for the current collector-side end edge thereof be located substantially on the same line.

Normally, as the negative electrode plate is larger than the positive electrode plate, when the above structure storing the positive electrode plate in the bag-shaped separator enables, the bag-shaped separator to be comparatively smaller than the structure storing the negative electrode plate in the bag-shaped separator. In this case, three end edges of the negative electrode plate except for the current collector-side end edge thereof, and three end edges of the bag-shaped separator except for the current collector-side end edge thereof are located substantially on the same line. Namely, by truing up three end edges of the negative electrode plate except for the current collector-side end edge thereof and three end edges of the bag-shaped separator except for the current collector-side end edge thereof, when the stack alignment in the three end edges occurs, the negative electrode plate comparatively protrudes from the bag-shaped separator. Therefore, the stack alignment is easily detected from outside. In contrast, at the current collector-side end edge of the bag-shaped separator, a short circuit tends to occur since it is impossible that the separator is welded at the position where the positive electrode current collector tab is disposed. Especially, it is desirable that a short circuit be prevented as much as possible, by largely extending the current collector-side end edge of the separator outside of the current collector-side end edge of the negative electrode plate facing the separator. However, in this structure of the current collector-side end edge, even though the stack misalignment occurs, it is difficult to detect the stack misalignment since the current collector-side end edge of the negative electrode plate does not protrude from the current collector-side end edge of the separator. Therefore, as mentioned above, by forming the projecting piece for positioning in the negative electrode current collector tab, the presence of the stack misalignment can be easily detected even in the current collector-side end edge.

It is desirable that the thickness of the projecting piece for positioning be 0.03 mm or less.

It is desirable that of the stacked positive or negative electrode plates, the projecting pieces for positioning of the electrode plates of the same polarity be disposed at a the position where they are each overlapped in the plan view.

Accordingly, as the positions of the projecting piece for positioning in the stacked plural positive or negative electrode plates are trued up, the presence of the stack misalignment in the stacked electrode assembly can be easily inspected.

Further, a manufacturing method of the present disclosure for a stack type battery containing a step of preparing a stacked electrode assembly by alternately stacking a positive electrode plate having a positive electrode current collector tab extending therefrom and a negative electrode plate having a negative electrode current collector tab extending therefrom interposing the separators therebetween, comprises forming a through portion for positioning that passes through in the thickness direction in at least one of the positive and negative electrode current collector tabs, and inspecting the presence of position misalignment between an end edge of the positive or negative electrode plate and an end edge of the separator by using the through portion for positioning, wherein at an extending height position along the extending direction of the positive or negative electrode collector tab having the through portion for positioning, the width in the direction perpendicular to the extending direction of the positive or negative electrode current collector tab at the through portion-unformed position where the through portion for positioning is not formed is 50 mm or more, and the width of the through portion for positioning in the direction perpendicular to the extending direction of the positive or negative electrode collector tab is 10% or less, or preferably less than 10%, or more preferably 5% or less of the width in the direction perpendicular to the extending direction of the positive or negative electrode collector tab at the through portion-unformed position.

Accordingly, for example, even when the current collector-side end edge of the separator facing the positive or negative electrode plate, is formed so as to largely extend outside from the positive or negative current collector side end edge, by inspecting the presence of the position misalignment between the through portion for positioning and the current collector-side end edge of the separator, the presence of the position misalignment between the positive or negative electrode plate and the separator can be easily and accurately detected.

At this time, the width in the direction perpendicular to the extending direction of the positive or negative electrode current collector at the through portion-unformed position is 50 mm or more, and the width of the through portion for positioning is 10% or less, or preferably less than 10%, or more preferably 5% or less of the width of the positive or negative electrode current collector tab at the through portion-unformed position (a width left by subtracting the width of the -through portion for positioning from the width of the positive or negative electrode current collector tab at the through portion-unformed position is 90% or more, or preferably more than 90%, or more preferably 95% or more of the width of the positive or negative electrode current collector tab at the through portion-unformed position). Even though the through portion is formed in the positive or negative electrode current collector tab, the width of the positive or negative electrode current collector tab at the through portion-formed position can be 45 mm or more. Therefore, the sectional area of the positive or negative electrode current collector tab is large. Namely, though the sectional area of the positive or negative electrode current collector tab is decreased by forming the through portion for positioning at that position, the necessary sectional area can be obtained for the current collector tab to flow a large current.

Namely, this through portion can have the large sectional area at the through portion-formed position, because of the following reasons. The through portion for positioning does not have a function or an effect that the small sectional area portion disclosed in the above mentioned patent literature 1 and 2 facilitates bending of the current collector tab, and the through portion does not work as a function of a fuse by a short circuit current. Accordingly, the current collector tab is not fused by a large current at the through portion-formed position. Therefore, the stack type battery having the large stacked electrode assembly which can charge and discharge with a large current can be obtained.

It is desirable that the inspection of the presence of the position misalignment be carried out after the completion of the stacked electrode assembly in the step of preparing the stacked electrode assembly.

Here, “the completion of the stacked electrode assembly” does not include a step of bundling the positive or negative electrode current collector tab in the stacked electrode assembly or connecting to the positive or negative electrode collector terminal.

Accordingly, the presence of the stack misalignment can be adequately inspected in the whole stacked electrode assembly.

It is desirable that the inspection of the presence of the position misalignment be carried out by detecting the through portion for positioning by laser from one surface side or the other surface side.

Accordingly, the presence of the position misalignment can be easily inspected.

The positive or negative electrode current collector tab in which the through portion for positioning is formed is bent and connected to the positive or negative electrode collector terminal, and it is desirable that the through portion for positioning be located between the stacked electrode assembly and the bent portion.

Accordingly, even after forming the stacked electrode assembly, the presence of the position misalignment between the through portion for positioning and the current collector-side end edge of the separator can be inspected. In addition, as the through portion for positioning is located between the stacked electrode assembly and the bent portion, the through portion for positioning is clearly different from the portion which facilitates bending of the current collector tab.

It is desirable that in the positive or negative electrode collector tab in which the through portion for positioning is formed, a bending line (a crease) be made by bending in advance.

Accordingly, at the time of shaping the current collecting portion by bending the current collector tab, the current collector tab is easily and surely bent at a predetermined bending position. For example, bending at the through portion for positioning in error is effectively prevented.

Here, in this case, the bending line (the crease) is formed by bending each of the current collector tab, or by bending the current collector tabs by 2 to 5 sheets of the current collector tabs. Further, as this bending is carried out in advance before stacking the positive electrode plate, the negative electrode plate, and the separator, the bending line (the crease) is formed in advance.

It is desirable that a stacked electrode assembly-side end edge of the through portion for positioning be located within a range of ±1 mm (preferably ±0.4 mm) from the current collector-side end edge of the facing separator at an extending height position along the extending direction of the positive or negative electrode current collector tab.

Accordingly, as the stacked assembly electrode-side end edge of the through portion for positioning substantially coincides with the current collector-side end edge of the facing separator, the presence of the position misalignment between the through portion for positioning and the current collector-side end edge of the facing separator can be exactly inspected. Namely, by forming the through portion for positioning in this position, the stack misalignment in the state of the stacked electrode assembly can be easily inspected.

In this case, for example, when the stacked electrode assembly-side end edge of the through portion for positioning projects from the current collector-side end edge of the facing separator by 1 mm or more (or 0.4 mm or more), it is determined that the stack misalignment occurs.

It is desirable that the separator have a bag-shape, and the positive or negative electrode plate be stored in the bag-shaped separator.

Accordingly, it is surely prevented that a short circuit occurs due to a contact between the positive electrode plate and the negative electrode plate caused by the stack misalignment.

The positive electrode plate, the negative electrode plate, and the bag-shaped separator have a square shape, and the positive electrode plate is stored in the bag-shaped separator, and the through portion for positioning is formed in the negative electrode current collector tab, and three side end edges of the negative electrode plate except for the current collector-side end edge thereof, and it is desirable that three side end edges of the bag-shaped separator except for the current collector-side end edge thereof be located substantially on the same line.

Here, the end edge of the negative electrode plate and the end edge of the separator is located substantially on the same line, which means that one end edge is located within a range of approximately ±1 mm from the other end edge.

Normally, as the negative electrode plate is larger than the positive electrode plate, when the above structure storing the positive electrode plate in the bag-shaped separator allows the bag-shaped separator to be comparatively smaller than those storing the negative electrode plate. In this case, three end edges of the negative electrode plate except for the current collector-side end edge thereof, and three end edges of the bag-shaped separator except for one the current collector-side end edge thereof are located substantially on the same line. Namely, by truing up three end edges of the negative electrode plate except for the current collector-side end edge thereof and three end edges of the bag-shaped separator except for the current collector-side end edge thereof, when the stack misalignment occurs at the three end edges, the negative electrode plate comparatively protrudes from the bag-shaped separator. Therefore, the stack misalignment is easily detected from the outside. In contrast, at the current collector-side end edge of the bag-shaped separator, a short circuit tends to occur since the separator cannot be welded at the position where the positive electrode current collector tab is disposed. Especially, it is desirable that the short circuit be prevented as much as possible by extending the current collector-side end edge of the separator largely outside the current collector-side end edge of the negative electrode plate facing the separator. However, in this structure of the current collector-side end edges, even though the stack misalignment occurs, it is difficult to detect the stack misalignment since the current collector-side end edge of the negative electrode plate does not protrude from the current collector-side end edge of the separator. Therefore, as mentioned above, by forming the through portion for positioning in the negative electrode current collector tab, the presence of the stack e misalignment can be easily detected even in the current collector-side end edge.

It is desirable that the thickness of the positive or negative electrode current collector tab in which the through portion for positioning is formed be 0.03 mm or less.

Accordingly, the current collector tab is easily bent, and the current collecting portion is easily formed. Further, the stack type battery having high energy density can be obtained. Furthermore, a member cost can be reduced.

It is desirable that of the positive or negative electrode current collector tabs in which the through portion for positioning is formed, the electrode current collector tabs of the same polarity be disposed at the position where they are each overlapped in the plan view.

Accordingly, as the positions of the through portions for positioning in the plural stacked positive electrode current collector tabs or negative electrode current collector tabs are trued up, the presence of the stack misalignment in the stacked electrode assembly can be easily inspected.

A manufacturing method of the present disclosure for a stacked battery containing a step of preparing a stacked electrode assembly by alternately stacking a positive electrode plate having a positive electrode current collector tab extending therefrom and a negative electrode plate having a negative electrode current collector tab extending therefrom interposing the separators therebetween, comprises forming a projecting piece for positioning, partially projecting from an end edge of at least one of the positive and negative electrode plate, and inspecting the presence of a position misalignment between an end edge of the positive or negative electrode plate and an end edge of the separator by using the projecting piece for positioning.

Accordingly, for example, even when the end edge of the separator facing the end edge of the positive or negative electrode plate is formed so as to extend largely outside, the presence of the position misalignment between the positive or negative electrode plate and the separator can be easily and accurately detected by inspecting the presence of the position misalignment between the projecting piece for positioning and the end edge of the separator.

It is desirable that the inspection of the presence of the position misalignment be carried out after a completion of the stacked electrode assembly in the step of preparing the stacked electrode assembly.

Accordingly, the presence of the stack misalignment can be adequately inspected in the whole stacked electrode assembly.

It is desirable that the inspection of the presence of the position misalignment be carried out by detecting the projecting piece for positioning by laser from one surface side or the other surface side.

Accordingly, the presence of the position misalignment can be easily inspected.

It is desirable that the projecting piece for positioning be formed at the current collector-side end edge of the at least one of the positive and negative electrode plates.

The projecting piece for positioning might be formed at any one of the end edges of the positive or negative electrode plate. However, at the current collector-side end edge, when the current collector-side end edge of the facing separator largely protrudes outside, it is difficult to detect the stack misalignment even though it occurs. Therefore, by forming the projecting piece for positioning, the presence of the stack misalignment can be easily and exactly detected.

It is desirable that at a projecting height position along the extending direction of the projecting piece for positioning, a tip portion of the projecting piece for positioning be located within a range of ±1 mm (preferably ±0.4 mm) from the end edge of the facing separator.

Accordingly, as the tip portion of the projecting piece for positioning substantially coincides with the end edge of the facing separator, the presence of the position misalignment between the projecting piece for positioning and the end edge of the separator can be exactly inspected. Namely, by forming the tip portion of the projecting piece for positioning in this position, the stack misalignment in the state of the stacked electrode assembly can be easily inspected.

In this case, for example, when the tip portion in the projecting piece for positioning projects from the end edge of the separator by 1 mm or more, it is determined that the stack misalignment occurs.

It is desirable that the width of the projecting piece for positioning in the direction perpendicular to the projecting direction thereof be 1 to 10 mm.

When the width of the projecting piece for positioning in the direction perpendicular to the projecting direction thereof is 1 mm or more, the presence of the position misalignment between the projecting piece and the facing separator is easily detected. And the projecting piece is good in mechanical strength, and it is hardly damaged. On the other hand, when the width of the projecting piece for positioning in the direction perpendicular to the projecting direction thereof is 1 mm or less, the width of the projecting piece is within a range not exceeding the required size. Accordingly, as in the case of the current collector tab, it is possible to suppress the unexpected increase in the portion susceptible to the short circuit.

It is desirable that the separator have a bag-shape, and the positive or negative electrode plate be stored in the bag-shaped separator.

Accordingly, it is surely prevented that the short circuit occurs due to a contact between the positive electrode plate and the negative electrode plate caused by the stack misalignment.

The positive electrode plate, the negative electrode plate, and the bag-shaped separator have a square shape, and the positive electrode plate is stored in the bag-shaped separator, and the projecting piece for positioning is formed at the current collector-side end edge of the negative electrode plate, and three end edges of the negative electrode plate except for the current collector-side end edge thereof, and it is desirable that three end edges of the bag-shaped separator except for the current collector-side end edge thereof be located substantially on the same line.

Normally, as the negative electrode plate is larger than the positive electrode plate, when the above configuration storing the positive electrode plate in the bag-shaped separator allows the bag-shaped separator to be comparatively smaller than those storing the negative electrode plate. In this case, three end edges of the negative electrode plate except for the current collector-side end edge thereof, and three end edges of the bag-shaped separator except for the current collector-side end edge thereof are located substantially on the same line. Namely, by truing up three end edges of the negative electrode plate except for the current collector-side end edge thereof, and three end edges of the bag-shaped separator except for one the current collector-side end edge thereof, when the stack misalignment occurs at the three end edges, the negative electrode plate comparatively protrudes from the bag-shaped separator. Therefore, the stack misalignment is easily detected from the outside. In contrast, at the current collector-side end edge of the bag-shaped separator, a short circuit tends to occur since the separator cannot be welded at the position where the positive electrode current collector tab is disposed. Especially, it is desirable that a short circuit can be prevented as much as possible by extending the current collector-side end edge of the separator largely outside the current collector-side end edge of the negative electrode plate facing the separator. However, in this structure of the current collector-side end edges, even though the stack misalignment occurs, it is difficult to detect the stack misalignment since the current collector-side end edge of the negative electrode plate does not protrude from the current collector-side end edge of the separator. Therefore, as mentioned above, by forming the projecting piece for positioning in the negative electrode current collector tab, the presence of the stack misalignment can be easily detected even in the current collector-side end edge.

It is desirable that the thickness of the projecting piece for positioning be 0.03 mm or less.

It is desirable that of the stacked positive or negative electrode plates, the projecting piece for positioning of the electrode plates of the same polarity be disposed at the position where they are each overlapped in the plan view.

Accordingly, as the positions of the projecting pieces for positioning in the plural stacked positive or negative electrode plates are trued up, the presence of the stack misalignment in the stacked electrode assembly can be easily inspected.

In the present disclosure, the stack misalignment in the stacked electrode assembly of the stack type battery can be easily inspected.

### BRIEF DESCRIPTION OF DRAWINGS

FIG. 1 is a view showing parts of a stack type battery in one embodiment of the present invention, (a) is a plan view of a positive electrode plate, (b) is a perspective view of separators, (c) is a plan view of the bag-shaped separator in which the positive electrode plate is stored.

FIG. 2 is a plan view of a negative electrode plate used in the stack type battery in one embodiment of the present invention.

FIG. 3 is an exploded perspective view of a stacked electrode assembly used in the stack type battery in one embodiment of the present invention.

FIG. 4 is a plan view of the stacked electrode assembly used in the stack type battery in one embodiment of the present invention.

FIG. 5 is a schematic sectional view in a state in which an inspection of the stack misalignment of the stacked electrode assembly used in the stack type battery in one embodiment of the present invention is carried out.

FIG. 6 is a schematic sectional view after completion of shaping and connecting process of a current collecting portion in the stack type battery in one embodiment of the present invention.

FIG. 7 is a plan view of the stacked electrode assembly in which a positive or negative electrode collector terminal is connected to a positive or negative electrode current collector tab.

FIG. 8 is a perspective view in a state in which the stacked electrode assembly is stored in an outer case in the stack type battery in one embodiment of the present invention.

FIG. 9 is a plan view of a positive electrode plate used in a stack type battery in another embodiment of the present invention.

FIG. 10 is a plan view of a negative electrode plate used in a stack type battery in another embodiment of the present invention.

FIG. 11 is a schematic partial front view in a misalignment state in which a base end-side end edge a through portion for positioning of the negative electrode current collector tab is located outside a current collector-side end edge of a bag-shaped separator.

FIG. 12 is a schematic partial front view in a misalignment state in which a base end-side end edge a through portion for positioning of the negative electrode current collector tab is located inside a current collector-side end edge of a bag-shaped separator.

FIG. 13 is a plan view of a positive electrode plate used in a stack type battery in another embodiment of the present invention.

FIG. 14 is a plan view of a negative electrode plate used in the stack type battery in another embodiment of the present invention.

FIG. 15 is a schematic partial front view of a current collector tab in the stack type battery in another embodiment of the present invention.

### DESCRIPTION OF EMBODIMENTS

Hereinbelow, preferred embodiments of the present invention are concretely described referring to figures, but the present invention is not limited to the following preferred embodiments, and then various changes and modifications are possible unless such changes and variations depart from the scope of the invention.

### First Embodiment

### [Preparation of Positive Electrode Plate]

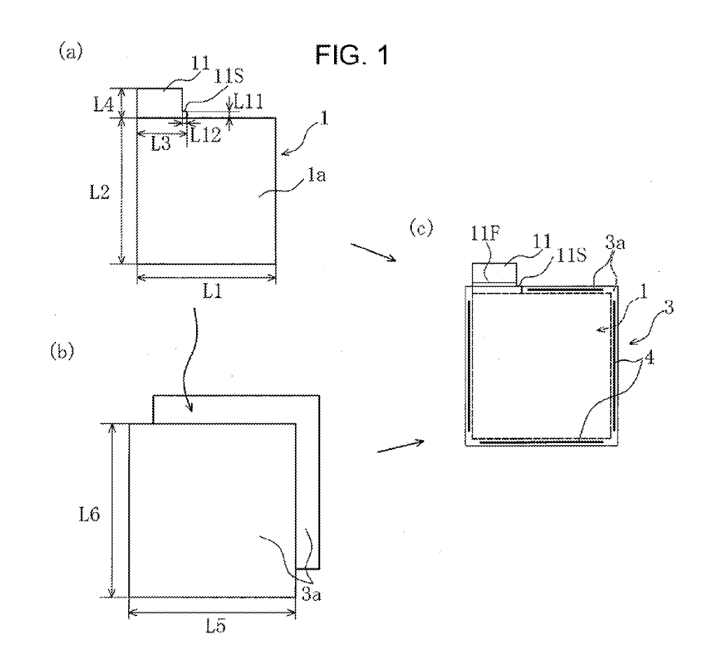

LiCoO₂ as the positive electrode active material, carbon black as a conductive agent, polyvinylidene fluoride (PVdF) as a binder were mixed in the ratio of 90:5:5 by mass. The resultant mixture was dispersed in N-methyl-2-pyrrolidone (NMP) as a solvent to make a positive electrode mixture slurry. This positive electrode mixture slurry was coated on both surfaces of an aluminum foil (15 μm (=micrometer) in thickness) as a positive electrode core. After that, the solvent was removed by heat, and it was pressed with a roll press so as to have a thickness of 0.1 mm, and then by cutting it into the size of a width L1=174 mm and a height L2=174 as shown in FIG. 1(a), the positive electrode plate 1 having the positive electrode active material 1a on both surfaces was made. At this time, the positive electrode current collector tab 11 was made by extending an active material non-coated portion of the size of a width L3=60 mm and a height L4=20 mm from one end portion (the left end portion of the upper side in FIG. 1(a)) of one side extending in the width L1 direction. Additionally, at this time, in the inside end portion (the right end portion in FIG. 1(a)) of both side end portions in the extending height L4 direction of the positive electrode current collector tab 11, a through portion for positioning 11S of a square cutout shape of a height of 15 mm and a width L12=2 mm was formed by cutting out an area which is higher than the height position of L11=5 mm from the lower end, and the width L12=2 mm from the end edge of the inside end portion.

### [Preparation of Negative Electrode Plate]

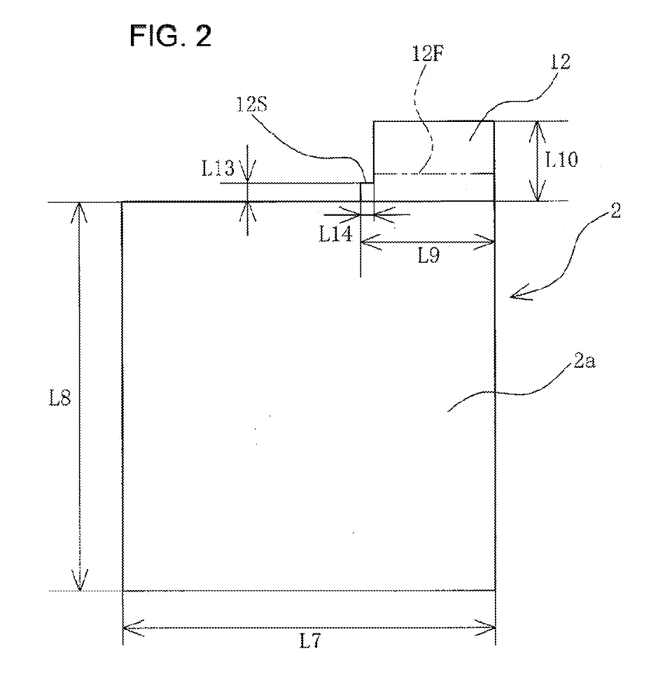

The graphite as the negative electrode active material, carboxymethylcellulose (CMC) as a thickener, and styrene-butadiene rubber (SBR) as a binder, were mixed in the ratio of 98:1:1 by mass and the mixture was dispersed in water to make a negative electrode mixture slurry. After that, this negative electrode mixture slurry was coated on both surfaces of a copper foil (10 μm (=micrometer) in thickness) as a negative electrode core. After that, water was removed by heat, and it was pressed with a roll press so as to have a thickness of 0.08 mm, and then by cutting it into the size of a width L7=180 mm and a height L8=180 as shown in FIG. 2, the negative electrode plate 3 having the positive electrode active material 3a on both surfaces was made. At this time, the negative electrode current collector tab 12 was made by extending an active material non-coated portion of the size of a width L9=60 mm and a height L10=20 mm from one end portion (the right end portion of the upper side in FIG. 2), extending in the width direction of the negative electrode plate 2, opposite to the positive electrode current collector tab 11 formed side end portion.

Additionally, at this time, in the inside end portion (the left end portion in FIG. 2) of both side end portions of the extending height L10 direction of the negative electrode current collector tab 12, a through portion for positioning 12S of a square cutout shape of a height of 18 mm and a width L14=2 mm was formed by cutting out an area which was higher than the height position of L13=2 mm from the lower end, and width L14=2 mm from the end edge of the inside end portion.

### [Preparation of Bag-Shaped Separator Storing Positive Electrode Plate]

As shown in FIG. 1(b), after the positive electrode plate was disposed between two sheets of square separators 3a made of polypropylene (PP) (30 μm in thickness) of the size of a width L5=180 mm and a height L6=182 mm, the periphery of the separators 3a except for the portion in which the positive electrode current collector tab 11 projected was weld-fixed to form the welding portion 4, and the bag-shaped separator 3 in which the positive electrode plate 1 was stored and disposed inside was made.

As mentioned above, the height L6=182 mm of the separator 3a was longer than the height L8=180 mm of the negative electrode plate 2 by 2 mm. Therefore, the bag-shaped separator 3 extended beyond the negative electrode plate 2 in the extending direction of the positive electrode current collector tab 11. Accordingly, a short circuit by misalignment of the negative electrode plates 2 hardly occurs.

### [Preparation of Stacked Electrode Assembly]

Nineteen sets of the bag-shaped separators 3 which stored the positive electrode plates 1 inside, and 20 sheets of the negative electrode plates were prepared. As shown in FIG. 1(c) and FIG. 2, several sheets (about 5 sheets) of each of the positive and negative electrode current collector tab 11, 12 (the positive electrode current collector tab 11 and the negative electrode current collector tab 12) were stacked, and at the position to the tip side by 4 mm from the base end-side end edge (the positive electrode active material layer 1a, 2a-side end edge; the lower end in FIG. 1(c) and FIG. 2) of the through portion 11S, 12S, extending portions to the tip side from this position were bent to one side (the front side or the back side in FIG. 1(c) and FIG. 2). Accordingly, bending lines 11F, 12F extending in the direction perpendicular to the extending direction of the positive or negative electrode current collector tab 11, 12 were formed.

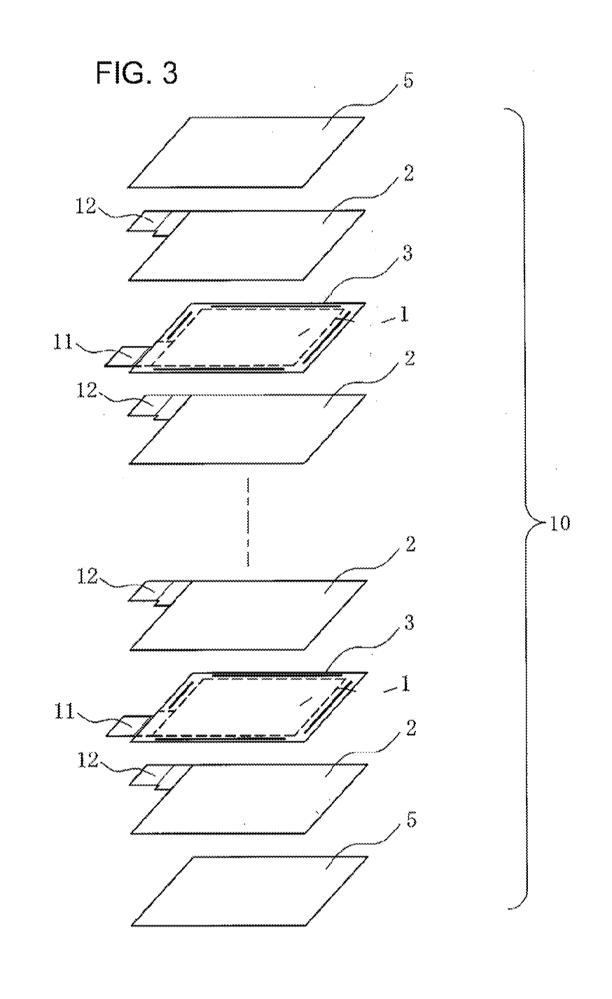

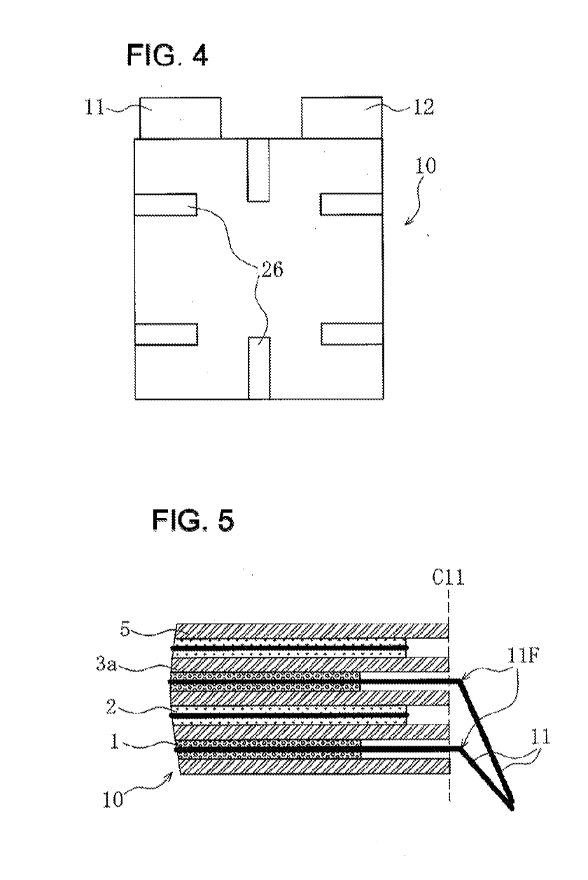

Further, as shown in FIG. 3, the above plural sheets (19 sheets) of the bag-shaped separators 3 and the above plural sheets (20 sheets) of the negative electrode plates were alternately stacked. At that time, the positive electrode current collector tabs 11 and the negative electrode current collector tabs 12 were disposed at the position where they were each overlapped in the plan view. Further, at the both end portions in the stacking direction, the negative electrode plates 2 were disposed, and insulating sheets 5 made of polypropylene (PP) and having the same size and shape as the separator 3a were each disposed outside the both end portions. After that, as shown in FIG. 4, the both end surfaces in the stacking direction of the stacked body were connected with insulating tape 26 for shape retention to obtain the stacked electrode assembly 10.

As shown in FIG. 5, the stacked electrode assembly 10 was kept in a recumbent posture so that the bending directions of the tips of the positive and negative electrode current collector tabs 11, 12 might be directed downward. And then, the base end-side end edges of the through portions 11S, 12S in the positive electrode current collector 11 and the negative electrode current collector 12 were each detected through image recognition by laser from the upper side, which is a detection position C11 shown in the same figure. By doing so, the presence of the misalignment between the current collector-side end edge of the bag-shaped separator 3 and the current collector-side end edge of the positive or negative electrode 1, 2 was detected. In three end edges except for the current collector-side end edge, whether or not the end edges of the negative electrode plate 2 protruded from the end edges of the bag-shaped separator 3 was inspected by laser.

### [Shaping and Connecting of Current Collecting Portion]

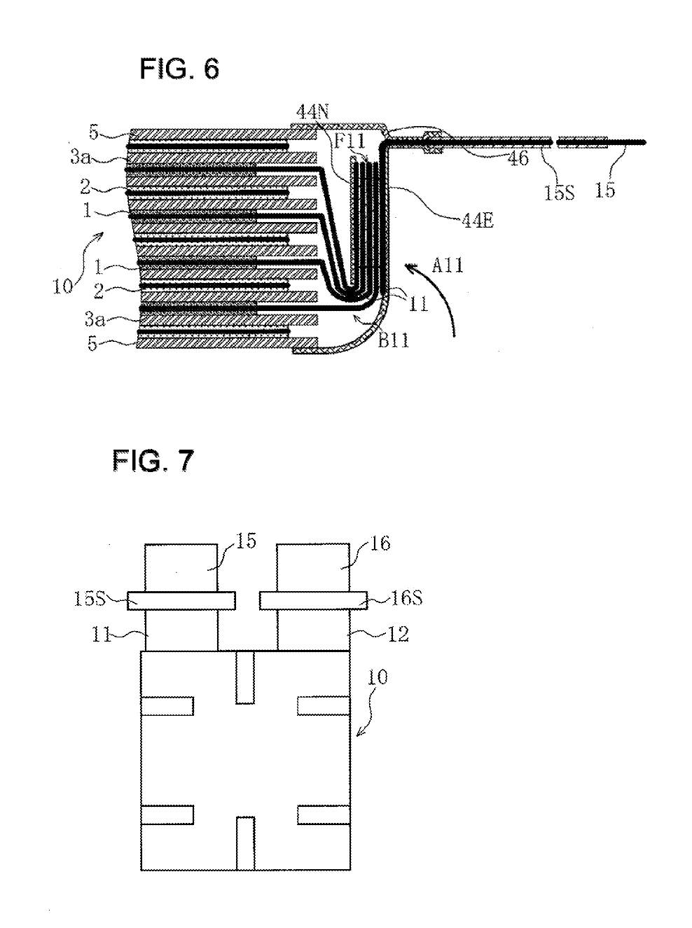

Next, as shown in FIG. 6, shaping (bundling, cutting, bending, or the like) the positive and negative electrode current collector tabs 11, 12 and connecting to the positive or negative electrode collector terminal 15, 16 in the above stacked electrode assembly 10 were carried out according to the following procedure. Here, the positive electrode side (the positive electrode current collector tab 11 and the positive electrode collector terminal 15) is fundamentally explained and shown in the following description, and FIG. 6 showing a schematic sectional view after completion of shaping and connecting process of the current collecting portion. At that time, similar procedures were carried out in the negative electrode side.

a) a first step (bundling and cutting of the positive and negative electrode current collector tabs)

The stacked electrode assembly 10 was kept in a recumbent state similar to the above inspection, and the stacked positive electrode current collector tabs 11 were bundled to one side (downward) in the stacking direction of the stacked electrode assembly 10. Next, an extra portion in an extending portion which extends to the tip side from the bundling portion B11 of the positive electrode current collector tab 11 was cut to align the tip.

b) a second step (connection of the positive and negative electrode collector terminals)

Next, the extending portion which extended to the tip side from the bundling portion B11 of the positive electrode current collector tabs 11 was disposed so as to overlap on the one end portion of the positive electrode collector terminal 15, and in this state, they were ultrasonic-welded, and as shown in FIG. 7, the positive electrode collector terminal 15 made of an aluminum plate of the size of width 60 mm, thickness 0.4 mm, and the negative electrode collector terminal 16 made of a copper plate of the size of width 60 mm, thickness 0.4 mm, were coupled to the tip portion of the positive or negative electrode current collector tab 11, 12. Here, FIG. 6 shows a shape after the extending portion which extends to the tip side from the bundling portion B11 of the positive electrode current collector tabs 11 is bent in the below-mentioned fifth step, but in the steps up to the below-mentioned fourth step, the extending portion which extends to the tip side from the bundling portion B11 of the positive electrode current collector tabs 11 extends straight in the extending direction of the positive electrode current collector tabs 11, namely in the right direction in FIG. 6.

Further, the reference numbers 15S and 16S in FIG. 6, FIG. 7, and other figures represent a resin sealing material (adhesive paste) which was formed in the shape of strip and fixed to the positive and negative electrode collector terminals 15, 16 along the width direction of each terminal to obtain sealability in sealing a below-mentioned outer case 18 by heat.

c) a third step (insulating layer)

As shown in FIG. 6, an inner insulating layer 44N is was formed by sticking insulating tape made of polyimide of the size of 61 mm×10 mm×thickness 35 μm to one side surface (the upper side surface; the left side surface in FIG. 6), which is the positive current collector tab 11-side surface, of the current collector connecting portion F11 (also hereinafter refer to as “positive electrode current collector connecting portion”) of the positive electrode current collector tab 11 and the positive electrode collector terminal 15, and an outer insulating layer 44E was formed by sticking insulating tape made of polyimide of the size of 61 mm×10 mm×thickness 70 μm to the other side surface (the lower side surface; the right side surface in FIG. 6), which is the positive electrode current collector terminal 15-side surface, of the positive electrode current collector connection portion F11.

Here, the insulating tape of the inner insulating layer 44N was stuck so as to cover from the vicinity of the bundling portion B11 of the positive electrode current collector tab 11 to the outside beyond the tip thereof. The insulating tape of the outer insulating layer 44E at the positive or negative electrode plate 1, 2 side (the plate base end side of the tab 11) was stuck so as to overlap with the tip edge portion of one side surface (namely, the under surface of the lower insulating sheet 5 in FIG. 6) in the stacking direction of the stacked electrode assembly 10, and the insulating tape of the inner insulating layer 44E at the output side of the current collecting portion (the tip side of the tab 11) was stuck so as to overlap the positive electrode collector terminal 15 and the tip portion of the resin sealing material (adhesive paste) 15S. Accordingly, the metal portion in the one side surface (the upper side surface), which was the positive electrode current collector tab 11-side surface, of the positive current collector connecting portion F11 was approximately completely covered with the inner insulating layer 44N. Further, in the other side surface (the lower side surface), which was the positive electrode collector terminal 15-side surface, the region between the insulating sheet 5 of the stacked electrode assembly 10 and the resin sealing material (adhesive paste) 15S, was completely covered with the outer insulating layer 44 E such that the metal portion was not exposed.

d) a fourth step (bending of the positive and negative electrode collector terminals)

Next, the projecting portion to the tip side from the positive electrode current collector connecting portion F11 in the positive electrode collector terminal 15 was bent downward (the right direction in FIG. 6) so as to become a hook shape (L-shape) in the side view.

e) a fifth step (bending and positioning of positive and negative electrode current collector connecting portions)

As shown in FIG. 6, the positive electrode current collector connecting portion F11 was bent inward as shown with the arrow A11 (upward in FIG. 6) at the positive and negative electrode current collector plates 1,2-side portion (the base end portion of the positive electrode current collector tab 11) rather than the positive electrode current collector connecting portion F11 so as to become approximately parallel with the stacking direction (the vertical direction of FIG. 6) of the stacked electrode assembly 10. Next, insulating tape 46 made of polyimide of the size of 61 mm×6 mm×thickness 35 μm was stuck from the tip side direction (the upper side in FIG. 6) of the positive electrode current collector connecting portion F11, so as to connect between the positive electrode collector terminal 15 and the stacked electrode assembly 10. Accordingly, the positive electrode current collector tab 11 was positioned while being kept in a predetermined bent state.

As mentioned above in the first step a) to the fifth step e), by bundling and bending the positive electrode current collector tab 11, the space saving of the positive electrode current collector tab 11 is effectively achieved.

[Insertion into Outer Case]

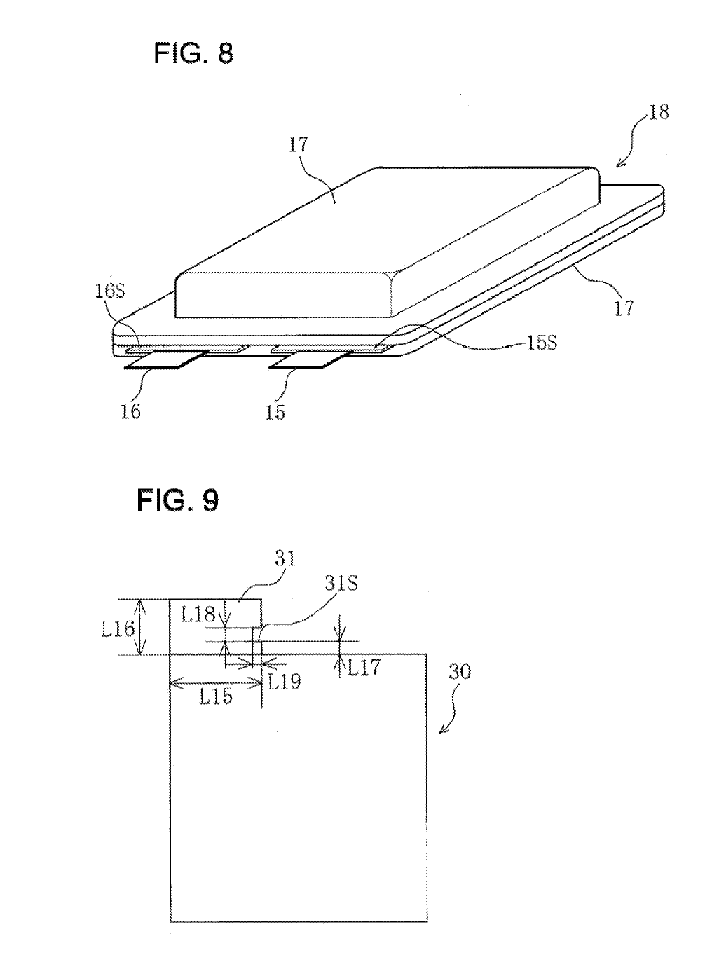

As shown in FIG. 8, the stacked electrode assembly 10 made in the above method was inserted into the outer case 18 made of a laminate film 17 which was formed in a shape so as to store the electrode assembly in advance. The peripheral sides except for the one side where the positive electrode current collector terminal 15 and the negative electrode current collector terminal 16 was placed, were thermally welded such that the positive electrode collector terminal 15 and the negative electrode collector terminal 16 projected from the outer case 18.

### [Injection of Non-Aqueous Electrolyte and Sealing]

Ethylene carbonate (EC), and diethyl carbonate (DEC) were mixed in the proportion of 30:70 by volume to prepare a mixed solvent, and LiPF₆ as an electrolyte salt was dissolved to be 1.2 mol/L in the mixed solvent to prepare a non-aqueous electrolyte. And the non-aqueous electrolyte was injected through the one side which had not been thermally welded in the outer case 18. Finally, the one side which had not been thermally welded in the outer case 18 was sealed by thermal welding, and battery A1 was made.

### Second Embodiment

### [Preparation of Positive Electrode Plate]

As shown in FIG. 9, the positive electrode current collector tab 31 of the size of width L15=74 mm and height L16=25 mm was provided.

In the inside edge portion (the right side edge portion in FIG. 9) of both side edge portions in the direction of the extending height L16 of the positive electrode current collector tab 31, a through portion 31S of a height L18=3 mm and a width L19=2 mm was formed by cutting out an rectangular area which was higher than the height position of L17=5 mm from the lower end. Except for the above portions, in the same way as the positive electrode plate 1 of the battery A1 in the above first embodiment, the positive electrode plate 30 was prepared.

### [Preparation of Negative Electrode Plate]

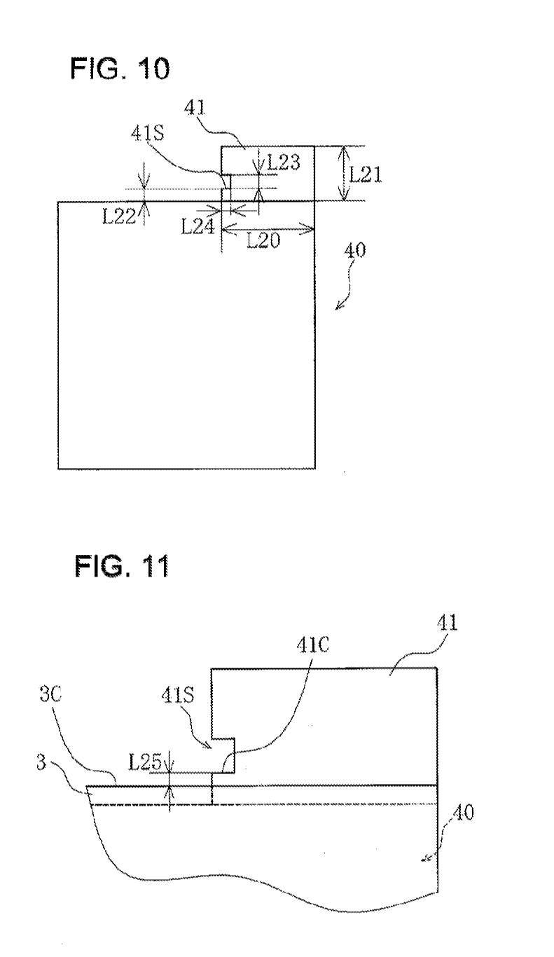

As shown in FIG. 10, the negative electrode current collector tab 41 of the size of a width L20=74 mm and a height L21=25 mm was provided. In the inside edge portion (the left side edge portion in FIG. 10) of both side edge portions in the direction of the extending height L21 of the positive electrode current collector tab 41, a through portion 41S of a height L23=3 mm and a width L24=2 mm was formed by cutting out a recess of a square shape from the inside edge portion which is higher than the height position of L22=2 mm from the lower end. Except for the above portions, in the same way as the negative electrode plate 2 of the battery A1 in the above first embodiment, the negative electrode plate 40 was prepared.

### [Preparation of Stacked Electrode Assembly]

Except for the above positive electrode plate 30 and the negative electrode plate 40, in the same way as the stacked electrode assembly 10 of the battery A1 in the above first embodiment, a stacked electrode assembly (not shown in the figure) was prepared, and the presence of misalignment of the stacked electrode assembly was inspected in the same way as the above first embodiment.

In this inspection, in the same way as the above first embodiment, a base end-side end edge of each of the through portions for positioning 31S, 41S of the positive or negative electrode current collector tab 31, 41 was detected. At this time, when the base end-side end edge of each of the through portions 31S, 41S and the base end-side end edge of the bag-shaped separator 3 are located at exactly the same position, it is determined that misalignment does not occur at the current collector-side end edge. However, it is not required that they are located at exactly the same position in this way for such determination. For example, as shown in FIG. 11, the base end-side end edge 41C of the through portion 41S sometimes projects by short distance L25 outside beyond the current collector-side end edge 3C of the bag-shaped separator 3. When the distance L25 of this outside misalignment is less than 1 mm (or less than 0.4 mm), it is determined that misalignment does not occur at the current collector-side end edge. Namely, when it is detected that the base end-side end edge of the through portion 31S, 41S of the positive or negative electrode current collector tab 31, 41 projects by 1 mm or more (or 0.4 mm or more) outside beyond the current collector-side end edge 3C of the bag-shaped separator 3, it is determined that misalignment occurs at the current collector-side end edge.

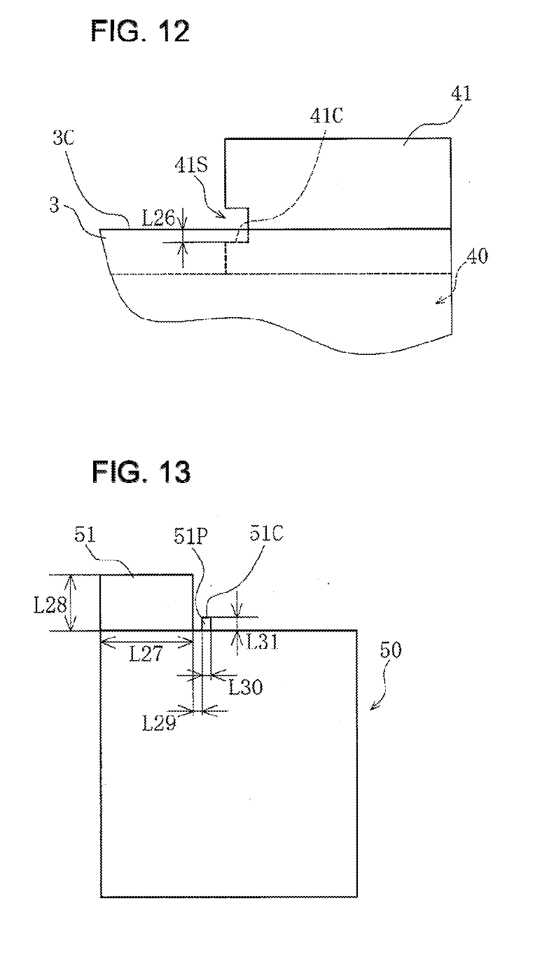

Here, in the contrast to the above case, for example, as shown in FIG. 12, when the base end-side end edge 41C of the pass-through portion 41S of the negative electrode current collector tab 41 is sometimes located by distance L26 inside the current collector-side end edge 3C of the bag-shaped separator 3. In this case, regardless of the distance L26, the presence of misalignment can be determined by inspecting whether or not the other side (opposite side) end edge in parallel with the base end-side end edge of the negative electrode plate 40 projects by 1 mm or more (or 0.4 mm or more) outside beyond the end edge of the facing bag-shaped separator 3. On the other hand, the other side (opposite side) end edge in parallel with the end base end-side edge of the positive electrode plate 30 is stored inside the end edge of the facing bag-shaped separator 3, and almost all of the end edge of the bag-shaped separator 3 is almost entirely sealed thermally at the welding portion 4. Therefore, the positive electrode plate 30 hardly projects outside beyond the end edge of the bag-shaped separator 3, and it is not required to inspect the presence of misalignment of the positive electrode plate 30 at such end edge.

Except for using the stacked electrode assembly prepared and inspected as mentioned in the above, in the same way as the battery A1 of the above first embodiment, a battery A2 was made.

The through portions 31S, 41S in the battery A2 of the above second embodiment has approximately the same function as the through portions 11S, 12S of the battery A1 of the above first embodiment. According to the configuration of the battery A2 of the second embodiment, compared to that of the battery A1 of the first embodiment, the positive or negative electrode current collector tab 31, 41 has a shape whose end edge projects to the inside in the width direction than the through portions for positioning 31S, 41S. Therefore, the projection secures the larger area of the current path in the positive or negative electrode current collector tab 31, 41 while it tends to be an obstacle.

### Third Embodiment

### [Preparation of Positive Electrode Plate]

As shown in FIG. 13, the positive electrode current collector tab 51 of the square size of a width L27=74 mm and a height L28=25 mm was provided, and a square projecting piece 51P of the size of a width L30=2 mm and a height L31=5 mm in the same direction as the positive electrode current collector tab 51 extends at an interval L29 of about 2 mm to the inside (right side in FIG. 13) from the positive electrode current collector tab 51 in the width direction. Except for the above portions, in the same way as the positive electrode plate 30 of the battery A2 in the above second embodiment, the positive electrode plate 50 was prepared.

### [Preparation of Negative Electrode Plate]

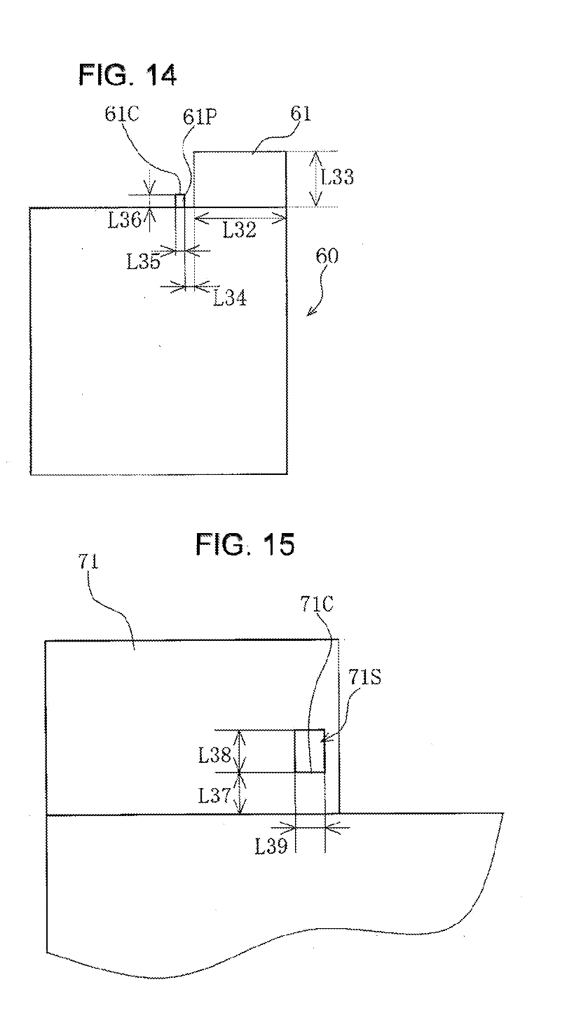

As shown in FIG. 14, the negative electrode current collector tab 61 of the square size of a width L32=74 mm and a height L33=25 mm was provided, and a square projecting piece 61P of the size of a width L35=2 mm and a height L36=2 mm in the same direction as the negative electrode current collector tab 61 extends at an interval of L34 about 2 mm to the inside (left side in FIG. 14) from the negative electrode current collector tab 61 in the width direction. Except for the above portions, in the same way as the positive electrode plate 40 of the battery A2 in the above second embodiment, the positive electrode plate 60 was prepared.

### [Preparation of Stacked Electrode Assembly]

Except for using the above positive electrode plate 50 and the negative electrode plate 60, the stacked electrode assembly (not shown in the figure) was prepared in the same way as the stacked electrode assembly of the battery A2 in the above second embodiment, and except for using the projecting piece 51P, 61P, the presence of stack misalignment of the stacked electrode assembly was inspected in the same way as the battery A2 of the above second embodiment.

In this inspection, the tip end edge of the square projecting pieces 51P, 61P was detected. The presence of misalignment was determined in the same way as the battery A2 of the above second embodiment.

Except for using the above prepared and inspected stacked electrode assembly a battery A3 was made in the same way as the battery A2 of the above second embodiment.

The projecting pieces 51P, 61P for positioning in the battery A3 of the above third embodiment has approximately the same function as the through portions 11S, 12S for positioning of the battery A1 of the above first embodiment, and the through portions 31S, 41S for positioning of the battery A2 of the above second embodiment. According to the configuration of the battery A3 of the third embodiment, compared with the battery A1 of the first embodiment and the battery A2 of the second embodiment, the projecting pieces 51P, 61P for positioning are configured to extend from the positive and negative electrode plates 50, 60 independently of the positive and negative electrode current collector tabs 51, 61. Accordingly, the positive and negative electrode current collector tabs 51, 61 can be advantageously formed in a square shape without a cutout of the positive and negative electrode current collector tabs 51, 61.

### [Other Matters]

(1) In the first, second, and third embodiment, the through portions 11S, 12S, 31S, 41S for positioning and the projecting piece 51P, 61P for positioning were formed in both of the positive electrode plate 1, 30, 50 and the negative electrode plate 2, 40, 60, but the through portion for positioning or the projecting piece for positioning can be formed in only one of the positive and negative electrode plates. It is desirable that the through portion for positioning and the projecting piece for positioning be formed in both of the positive or negative electrode plates in order to adequately inspect the presence of the misalignment. As mentioned above, when the end edge of the separator is formed to extend largely outside beyond the end edge of the negative electrode plate, it is difficult to detect the misalignment at both end edges. In this case, it is desirable that the through portion for positioning or the projecting piece for positioning be formed at least in such end edge of the negative electrode plate.

(2) In the above third embodiment, the projecting piece 51P, 61P for positioning were each formed at the current collector-side end edge of the positive electrode plate 50 and the negative electrode plate 60, but the projecting piece for positioning can be formed at an end edge other than the current collector-side end edge. As mentioned above, in case of the end edge other than the current collector-side end edge, by truing up with the end edges of the corresponding separator, the presence of the misalignment in this end edge can be easily detected from the outside. In addition, especially when the electrode plate (the positive or negative electrode plate) is stored in the bag-shaped separator, it is almost unnecessary to detect the misalignment at the end edge other than the end edge to the current collector side. Accordingly, it is desirable that the projecting piece for positioning be formed at least at the current collector-side end edge of the positive or negative electrode plate.

(3) In the first and second embodiment, the through portions 11S, 12S, 31S, 41S for positioning were composed of a cutout which was provided so as to form a step by cutting a part of the end edge of the positive or negative current collector tab 11, 12, 31, 41. In addition, as the through portion for positioning, for example, as shown in FIG. 15, the opening (through hole) formed inside the end edge of the current collector tab (the positive or negative electrode current collector tab) 71 can be used. In the example of the same figure, the current collecting tab 71 has a square shape, and at an interval (1 to several mm) to the center side from the inside edge portion of both side edge portions in the extending height direction of the current collecting tab 71, the through portion 71S for positioning is formed as the size of a height L38=3 mm and width a L39=2 mm of the square opening (through hole) which is higher than the height position of a L37 from the lower end so as to be trued up at the current collector-side end edge of the separator. Except for the through portion 71S for positioning, the above example has the same configuration as the above second embodiment.

In the above case of the through portion for positioning 71S as the opening (through hole), in the same way as the through portions 11S, 12S, 31S, 41S composed of the cutout in the above first or second embodiment, by detecting whether or not the base end-side end edge (the lower end edge in FIG. 15) of the through portion 71S projects from the current collector-side end edge of the separator, the inspection of the misalignment can be carried out. Compared with the through portions 11S, 12S, 31S, 41S composed of the cutout in the above first or second embodiment, as the vicinity of the through portion 71S has a merit that it is hardly damaged. On the other hand, it tends to be slightly inferior in the ease of formation.

(4) In the above first, second, and third embodiment, the inspection of the misalignment in the stacked electrode assembly was carried out between the connecting and fixing process of the stacked electrode assembly 10 by the insulating tape 26, and the shaping and connecting process of the current collecting portion. However, for example, during stacking the electrode plates, namely, during the process of preparing the stacked electrode assembly (for example, during a step of stacking the negative electrode plates and the separators, during a step before fixing by a fixing means such as the insulating tape and the like after stacking), the inspection of the misalignment can be carried out. In other words, during or after the shaping and connecting process of the current collecting portion, a correction of the misalignment is difficult. However, in the earlier process, the inspection of the misalignment can be carried out at one or more arbitrary timings. Here, in order to inspect the presence of the misalignment in the whole stacked electrode assembly enough, it is desirable that the misalignment inspection be carried out after completion of stacking or fixing by the fixing mean. In addition, the misalignment inspection can be carried out even after the shaping and connecting process of the current collecting portion.

Further, for example, at the process of preparing the bag-shaped separator, the presence of the misalignment at the current collector-side end edge of the stored electrode plate can be inspected.

(5) In the above first, second, and third embodiment, as the outer case, the laminate film 17 constitutes the outer case 18. However, as the outer case, an arbitrary member besides the laminate film can be used, and for example, a battery can or the like can be used. However, in the case of using the laminate outer case, when the positive or negative electrode plate projects from the separator, the plate might break through the insulating layer of the laminate case and contact the metal layer, which causes a short circuit. Therefore, as the effect of the embodiments of the present invention, a projection of the positive or negative electrode plate is easily detected by the through portion for positioning or the projecting piece for positioning.

For example, the laminate film is composed of the following: a metal layer including aluminum, aluminum alloy, or stainless; an inner layer (the battery inside) including polyethylene or polypropylene; and an outer layer (the battery outside) including nylon, polyethylene terephthalate (PET), or a stacked film of PET/nylon.

The positive electrode active material is not limited to the above lithium cobalt oxide. The lithium composite oxide containing cobalt, nickel, or manganese such as cobalt-nickel-manganese, aluminum-nickel-manganese, aluminum-nickel-cobalt, or the like, and spinel type lithium manganese oxide can be used.

(7) As the negative electrode active material, various materials can be used besides graphite such as natural graphite and artificial graphite as long as the material is capable of intercalating and deintercalating lithium ions. Examples include graphite, coke, tin oxide, metallic lithium, silicon, and mixtures thereof.

(8) The electrolyte is not limited to the ones shown in the above examples. Examples of the lithium salt include LiBF₄, LiPF₆, LiCF₃SO₃, LiN(SO₂CF₃)₂, LiN(SO₂C₂F₆)₂, and LiPF₆₋ₓ(CₙF₂ₙ₊₁)ₓ[1<x<6, n=1 or 2], which may be used either alone or in combination. The concentration of the supporting salt is not particularly limited, but is preferably 0.8 to 1.8 mol/L. Further, besides the above EC and MEC as the types of the solvent, carbonate solvents such as propylene carbonate (PC), γ-butyrolactone (GBL), ethyl methyl carbonate (EMC), dimethyl carbonate (DMC), and diethyl carbonate (DEC) is preferable, and a combination of a cyclic carbonate and a chain carbonate is more preferable.

### INDUSTRIAL APPLICABILITY

The present invention can be used for a wide usage, and especially as a stacked battery having a large stacked electrode assembly, for example, it is suitable for a power source installed in a robot or an electric vehicle, and a power source for a high power usage such as a back-up power source.

### REFERENCE MARKS IN THE DRAWINGS

1: positive electrode plate
11: positive electrode current collector tab
11S: through portion for positioning
3: bag-shaped separator
3a: separator
L3: width of positive electrode collector tab at through portion-unformed position
L12: width of through portion for positioning

1. A stack type battery containing a stack type electrode assembly in which a positive electrode plate having a positive electrode current collector tab extending therefrom and a negative electrode plate having a negative electrode current collector tab extending therefrom are alternately stacked interposing a separator therebetween, comprising:
a through portion for positioning that passes through in the thickness direction formed in at least one of the positive or negative electrode current collector tab,
wherein at an extending height position along the extending direction of the positive or negative electrode current collector tab having the through portion for positioning, the width in the direction perpendicular to the extending direction of the positive or negative electrode current collector at the through portion-unformed position where the through portion for positioning is not formed is 50 mm or more, and the width of the through portion for positioning in the direction perpendicular to the extending direction of the positive or negative electrode current collector tab is 10% or less of the width in the direction perpendicular to the extending direction of the positive or negative electrode current collector tab at the through portion-unformed position.

2. The stack type battery according to claim 1,
wherein the positive or negative electrode current collector tab in which the through portion for positioning is formed is bent and connected to the positive or negative electrode collector terminal, and the through portion for positioning is located between the stacked electrode assembly and a bent portion.

3. The stack type battery according to claim 2,
wherein in the positive or negative electrode collector tab in which the through portion for positioning is formed, a bending line is made by bending in advance.

4. The stacked battery according to claim 1,
wherein at an extending height position along the extending direction of the positive or negative electrode collector tab, a stacked electrode assembly-side end edge of the through portion for positioning is located within a range of ±1 mm from a current collector-side end edge of the facing separator.

5. The stack type battery according to claim 1,
wherein the separator has a bag-shape, and the positive or negative electrode plate is stored in the bag-shaped separator.

6. The stack type battery according to claim 5,
wherein the positive electrode plate, the negative electrode plate, and the bag-shaped separator have a square shape, and the positive electrode plate is stored in the bag-shaped separator, and the through portion for positioning is formed in the negative electrode current collector tab, and three end edges of the negative electrode plate except for the current collector-side end edge thereof, and three side end edges of the bag-shaped separator except for the current collector-side end edge thereof are located substantially on the same line.

7. The stack type battery according to claim 1,
wherein the thickness of the positive or negative electrode current collector tab in which the through portion for positioning is formed is 0.03 mm or less.

8. The stack type battery according to claim 1,
wherein in the positive or negative electrode plate in which the through portion for positioning is formed, a plurality of electrode plates of the same polarity are disposed at a position where they are each overlapped in the plan view.

9. A stack type battery containing a stacked electrode assembly in which a positive electrode plate having a positive electrode current collector tab extending therefrom and a negative electrode plate having a negative electrode current collector tab extending therefrom are alternately stacked interposing a separator therebetween, comprising:
a projecting piece for positioning being formed, partially projecting from an end edge of at least one of the positive and negative electrode plates.

10. The stack type battery according to claim 9,
wherein the projecting piece for positioning is formed at an current collector-side end edge of the at least one of the positive and negative electrode plates.

11. The stack type battery according to claim 9,
wherein at a projecting height position along the projecting direction of the projecting piece for positioning, a tip portion of the projecting piece for positioning is located within a range of ±1 mm from an end edge of the facing separator.

12. The stack type battery according to claim 9,
wherein the width of the projecting piece for positioning in the direction perpendicular to the projecting direction thereof is 1 to 10 mm.

13. The stacked type battery according to claim 9,
wherein the separator has a bag-shape, and the positive or negative electrode plate is stored in the bag-shaped separator.

14. The stack type battery according to claim 13,
wherein the positive electrode plate, the negative electrode plate, and the bag-shaped separator have a square shape, and the positive electrode plate is stored in the bag-shaped separator, and the projecting piece for positioning is formed at a current collector-side end edge of the negative electrode plate, and three side end edges of the negative electrode plate except for the current collector-side end edge thereof and three side end edges of the bag-shaped separator except for the current collector-side end edge thereof are located substantially on the same line.

15. The stack type battery according to claim 9,
wherein in the stacked positive or negative electrode plates, a plurality of projecting pieces for positioning of the same polarity are disposed at a position where they are each overlapped in the plan view.

16-34. (canceled)
